(19) United States
(12) Patent Application Publication
(10) Pub. No.: US 2015/0283024 A1
(43) Pub. Date: Oct. 8, 2015

(54) MASSAGER FOR BODY CAVITIES AND METHODS FOR USING THE SAME

(71) Applicant: Jiro TAKASHIMA, Houston, TX (US)

(72) Inventor: Jiro TAKASHIMA, Houston, TX (US)

(21) Appl. No.: 14/713,838

(22) Filed: May 15, 2015

Related U.S. Application Data
(63) Continuation-in-part of application No. 13/731,839, filed on Dec. 31, 2012.
(60) Provisional application No. 61/994,118, filed on May 15, 2014.

(51) Int. Cl. A61H 15/00

(52) U.S. Cl. CPC A61H 15/0092; A61H 2201/1645

(57) ABSTRACT

The device for massaging a human body cavity includes a substantially cylindrical shaft having a length and a diameter configured to fit inside the human body cavity and an asymmetric edge created inside of any auxiliary symmetric figures such as triangles, squares, or ovals. The asymmetry of the massager's cross section allows for twisting motions when pressure from the body cavity is exerted on the massager.

### RELATED U.S. APPLICATIONS

The present application claims priority under 35 U.S.C. Section 119(e) from U.S. Provisional Patent Application Ser. No. 61/994,118, filed on May 15, 2014, entitled “MASSAGER FOR BODY CAVITIES AND METHODS FOR USING THE SAME”.

The present application is a continuation-in-part application under 35 U.S. Code Section 120 of U.S. application Ser. No. 13/731,839, filed on Dec. 31, 2012, and entitled “MASSAGER FOR BODY CAVITIES AND METHODS FOR USING THE SAME”, presently pending.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to devices that may be used as massagers in body cavities.

2. Description of Related Art including Information Disclosed under 37 CFR 1.97 and 37 CFR 1.98

The massager is a device for insertion into a body cavity of the human body. Some noninfectious disorders may be caused by circulation problems and/or homeostasis problems relating to fluid or electrolytes. Such disorders sometimes may be relieved by massage or other physical means. For example, a congested prostate may be remedied with prostate massage. Similarly, it is believed that hemorrhoid massage is effective in relieving symptoms by stimulating blood flow around the areas of the hemorrhoid tissues.

Prior art massagers often rely on external forces to effect the massaging actions. U.S. Pat. Nos. 5,797,950, 5,861,000, and 8,182,503 issued to the present inventor, disclose prostate massage devices that can be used without the application of external forces. Instead, these devices harness the contraction and relaxation forces of the sphincter muscles to provide the massage actions. These devices have structures interactive with the contraction forces of the sphincter, which can be translated into sliding motions of the devices.

It is an object of the present invention to provide a massager that is maintained in a body cavity of the human body.

It is an object of the present invention to provide a massager capable of a twisting action within the body cavity.

It is an object of the present invention to provide a massager with a surface interactive with the body cavity to rotate the massager relative to the surface of the body cavity.

It is another object of the present invention to provide a massager with an asymmetric surface interactive with the surface of the body cavity.

These and other objectives and advantages of the present invention will become apparent from a reading of the attached specifications and appended claims.

### SUMMARY OF THE INVENTION

Pending U.S. patent application Ser. No. 13/731,839 (hereinafter ORIGINAL APPLICATION) provides a massager for a body cavity having an asymmetric edge created inside of symmetric auxiliary circle. This Continuation in Part Application provides a massager for a body cavity having an asymmetric edge created inside of any other symmetric figures like triangles and squares etc.

### BRIEF DESCRIPTION OF THE DRAWINGS

FIG. 1 shows a side view of the body cavity massager 10 in accordance with one embodiment of the present invention.

FIG. 2 is a cross sectional view of the massager 10 from FIG. 1 inside an auxiliary triangle.

FIG. 3-1 is a cross sectional view of the massager 10 from FIG. 1 inside an auxiliary triangle with force vectors illustrating a working mechanism of the massager 40 in accordance with one embodiment of the present invention.

FIG. 3-2 illustrates the relational separation of the auxiliary triangle and the asymmetric cross-section.

FIG. 4-1 is a cross sectional view of the massager 40 inside an auxiliary rectangle with force vectors illustrating a working mechanism of the massager 40 in accordance with one embodiment of the present invention.

FIG. 4-2 illustrates the relational separation of the symmetrical auxiliary rectangle and the asymmetric cross section.

### DETAILED DESCRIPTION OF THE DRAWINGS

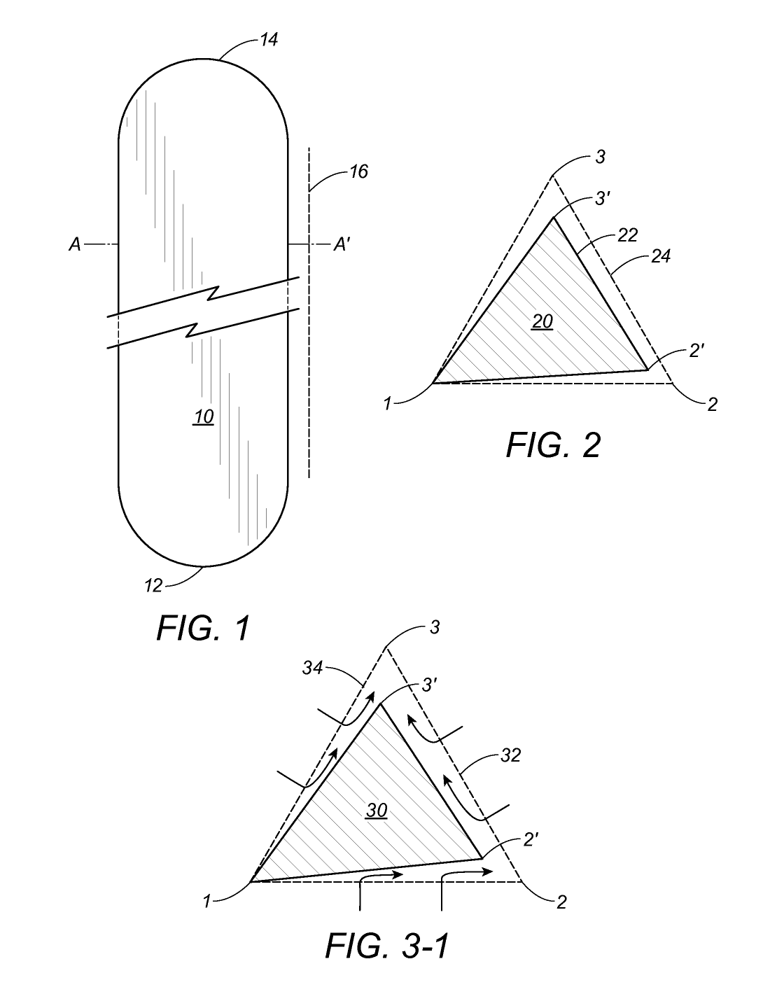

Referring to FIGS. 1-6, FIG. 1 shows a side view of the body cavity massager 10 in accordance with one embodiment of the invention. As shown in FIG. 1, massager 10 has a first end 12 and a second end 14. One point of the auxiliary figure 16 extended along the massager 10 is also shown.

FIG. 2 shows a cross-sectional view of the massager 10 shown in FIG. 1. The cross section 20 in FIG. 2 has an asymmetric edge created inside a auxiliary symmetric triangle 24.

An auxiliary triangle 24 is used to show a relative variation of the outer surface of the massager's triangular cross-section 22.

As Shown in FIG. 2 tracing the outer surface of the massager in a counterclockwise direction, the outer surface line 22 starts to extend from point 1 separating inwardly from auxiliary triangle 24 and extending to 2′. From point 2′, the outer surface 22 further separates from auxiliary triangle 24 while extending to point 3′, with a widest separation from ridge line 2′ to 3′. The outer surface then extends from point 3′ to point 1, closing the triangle.

The asymmetric line creates a “ridge” (or higher point) at point 1, and a lowest point at point 3′, relative to the auxiliary triangle 24.

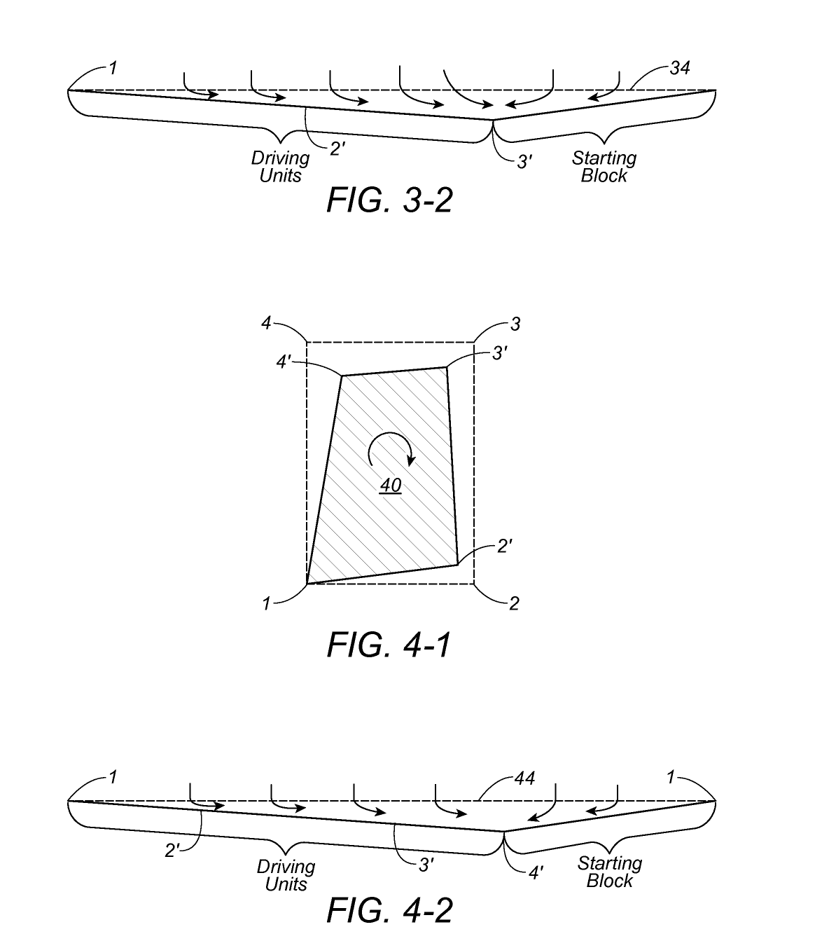

FIG. 3-1 shows a schematic illustrating one explanation of how the asymmetric forces act on the outer surface of the massager. When device 30 is inserted into a body cavity, it is compressed by the inner wall muscles in the body cavity, and the interaction of the body cavity and the massager may result in twisting actions of the massager. The vectors of the inner cavity pressure add to the massager 30, the vector goes higher place to lower place relative to the auxiliary triangle 34, 1 to 2′ and 2′ to 3′, counter clock wise, and 1 to 3′ clock wise, the total vectors will bend toward the longer downstream curvature counter clock wise.

FIG. 3-2 shows another schematic illustration explaining the working mechanism of the massager 10. The arrows show the directions of the vectors that represent the compression forces acting on the massager 30. In FIG. 3-2, the dotted line represents the “straightened” auxiliary triangle 34, while the solid line shows the “straightened” cross section. Deviations from the auxiliary triangle are readily observed. Points 1, 2′, and 3′ show the corner points of the triangle in FIG. 3-1.

FIGS. 4-1 and 4-2 illustrate a second embodiment of the massager 40 for a body cavity, wherein the cross section of the massager 40 is a trapezium, or a quadrilateral with no parallel sides. The same logic of forces acting upon a triangular massager described above applies to a quadrilateral massager.

Any symmetrical figure, such as an oval, a rectangle, etc., that have a width to height ratio within 1:1.5 can be used as an auxiliary figure.

I claim:

1. A massager of the body cavity having a length and a diameter to fit said body cavity, comprising:
an outer shape of the massager having an asymmetric edge created inside an auxiliary symmetric figure, including but not limited to an triangle, square, rectangle, or an oval, such that the outer shape of the massager increasingly separates inwardly from a starting point of the auxiliary symmetric figure to a point of widest separation between the auxiliary symmetric figure and decreasingly separates from the point of widest separation to the starting point of the auxiliary symmetric figure.

2. A device for massaging a human body cavity, comprising:
a substantially cylindrical shaft having a length and a diameter configured to fit inside the human body cavity; and
a ridge member on an outer surface of the substantially cylindrical shaft, said ridge member circumscribing the cylindrical shaft and running in a direction parallel a longitudinal axis of the cylindrical shaft,
wherein said ridge member and the cylindrical shaft have a cross-section with asymmetry corresponding to a auxiliary symmetric figure, and
wherein said ridge member has widest separation between the auxiliary symmetric figure and said cross-section between ends of the cylindrical shaft.

2. The device for massaging, according to claim 1, wherein said auxiliary symmetric figure is an equilateral triangle, and wherein said asymmetric cross-section section is an isosceles triangle.

3. The device for massaging, according to claim 1, wherein said auxiliary symmetric figure is a square, and wherein said cross-section is an asymmetric quadrilateral.

4. The device for massaging, according to claim 1, wherein said ridge member runs along a spiral path on said outer surface of the substantially cylindrical shaft.

5. A device for massaging a human body cavity, comprising:
a substantially cylindrical shaft having a length and a diameter configured to fit inside the human body cavity; and
a ridge member on an outer surface of the substantially cylindrical shaft, said ridge member circumscribing the cylindrical shaft and running in a direction parallel a longitudinal axis of the cylindrical shaft,
wherein said ridge member and the cylindrical shaft have an auxiliary symmetric figure a top plan view,
wherein said ridge member and the cylindrical shaft have a cross-section with asymmetry corresponding to said auxiliary symmetric figure, and
wherein said ridge member has widest separation between the auxiliary symmetric figure and said cross-section between ends of the cylindrical shaft.

6. The device for massaging, according to claim 5, wherein said auxiliary symmetric figure is a rectangle, and wherein said cross-section is an asymmetric quadrilateral.

7. The device for massaging, according to claim 5, wherein said ridge member runs along a spiral path on said outer surface of the substantially cylindrical shaft.
